(19) United States
(12) Patent Application Publication
(10) Pub. No.: US 2026/0101314 A1
(43) Pub. Date: Apr. 9, 2026

(54) METHODS AND APPARATUSES FOR PAGING RETRANSMISSION

(71) Applicant: InterDigital Patent Holdings, Inc., Wilmington, DE (US)

(72) Inventors: Anuj SETHI, Ottawa (CA); Guanzhou WANG, Brossard (CA); Michael STARSINIC, Newtown, PA (US); Samir FERDI, Kirkland (CA); Alec BRUSILOVSKY, Downingtown, PA (US); Mohamad Kenan AL-HARES, Canterbury (GB)

(73) Assignee: InterDigital Patent Holdings, Inc., Wilmington, DE (US)

(21) Appl. No.: 18/905,759

(22) Filed: Oct. 3, 2024

(51) Int. Cl. H04W 68/02; H04W 24/10

(52) U.S. Cl. CPC H04W 68/02; H04W 24/10

(57) ABSTRACT

Methods and apparatuses are described herein for paging retransmission. A wireless transmit/receive unit (WTRU) may receive, from a network node, a message comprising device information and paging configuration information. The paging configuration information may include paging retransmission instructions. The paging retransmission instructions may comprise a first instruction indicative of retransmission not required, a second instruction indicative of retransmission required, and a third instruction indicative of conditional retransmission required. The WTRU transmit, based on the device information, to a group of devices, a first paging message. Based on receiving one or more paging responses or receiving no responses, the WTRU may transmit, based on the paging retransmission instructions, a second paging message with an indication of paging retransmission.

### BACKGROUND

An ambient power-enabled IoT (AIoT) device refers to an Internet of Things device that captures energy from its surroundings, including sources like wireless radio waves, motion, vibration, piezoelectricity, solar, or wind power.

These devices either operate without batteries or have minimal energy storage, such as capacitors. However, AIoT devices encounter several challenges during energy harvesting, which can impact their performance, leading to issues like failure to send or receive messages.

### SUMMARY

Methods and apparatuses are described herein for paging retransmission. For example, a wireless transmit/receive unit (WTRU) may receive, from a network node, a message comprising device information and paging configuration information. The paging configuration information may include paging retransmission instructions. The paging retransmission instructions may comprise a first instruction indicative of retransmission not required, a second instruction indicative of retransmission required, and a third instruction indicative of conditional retransmission required. The WTRU may transmit, based on the device information, to a group of devices, a first paging message. Based on receiving one or more paging responses or receiving no responses, the WTRU may transmit, based on the paging retransmission instructions, a second paging message with an indication of paging retransmission.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a diagram illustrating an example network;

FIG. 3 is a diagram illustrating an example topology;

FIG. 4 is a diagram illustrating another example topology;

FIG. 5A is a diagram illustrating another example topology;

FIG. 5B is a diagram illustrating another example topology;

FIG. 6 is a diagram illustrating another example topology;

FIG. 7 is a diagram illustrating example architecture;

FIG. 8 is a diagram illustrating an example signal flow;

FIG. 9 is a diagram illustrating an example procedure; and

FIG. 10 is a diagram illustrating an example procedure.

### DETAILED DESCRIPTION

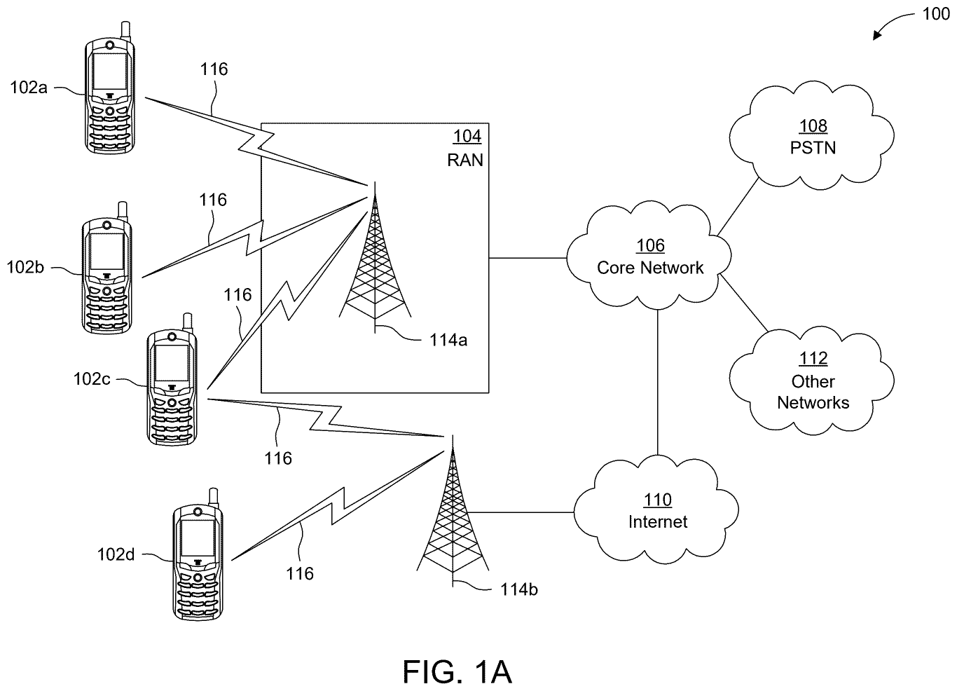

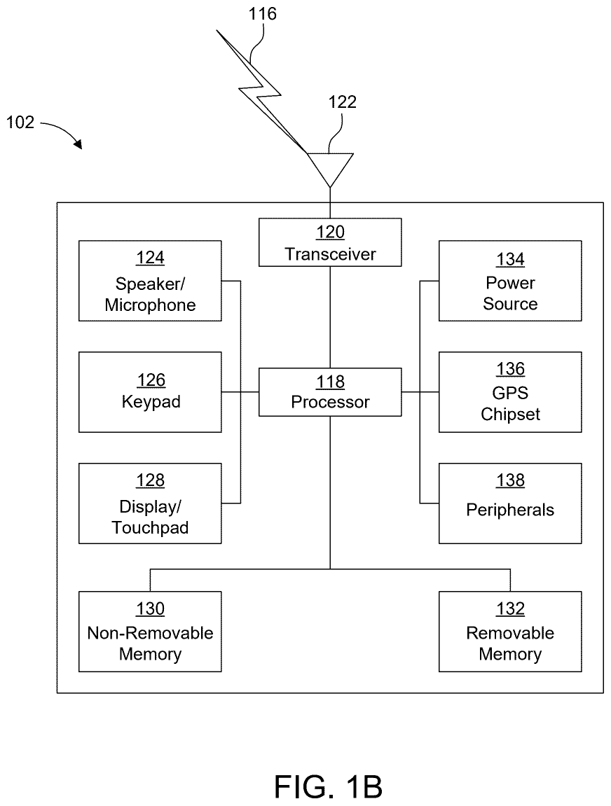

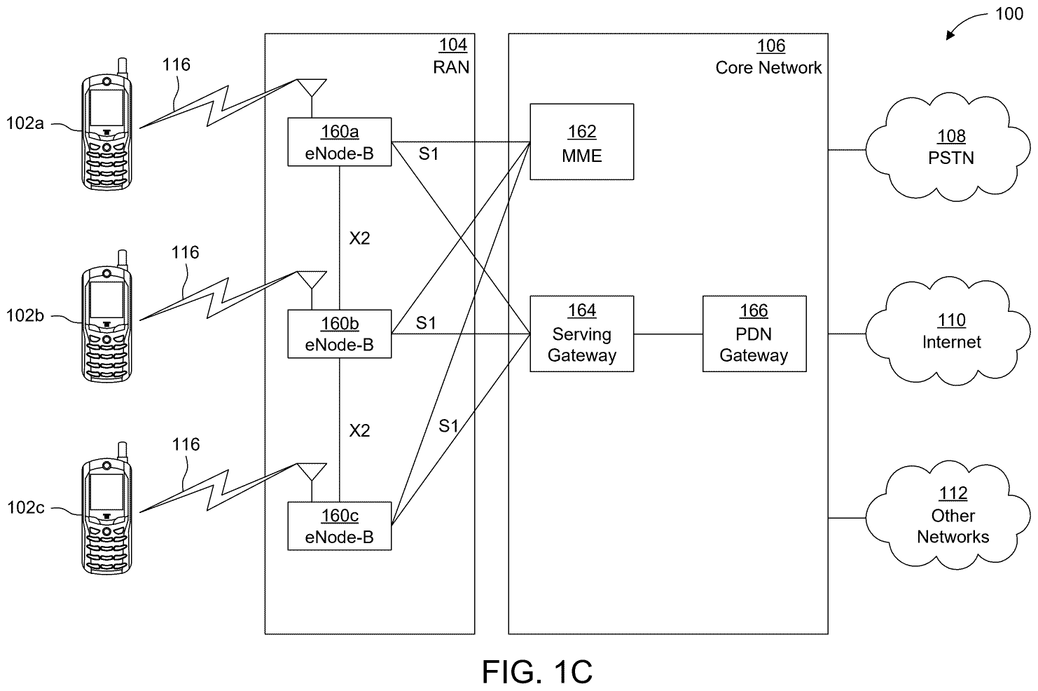

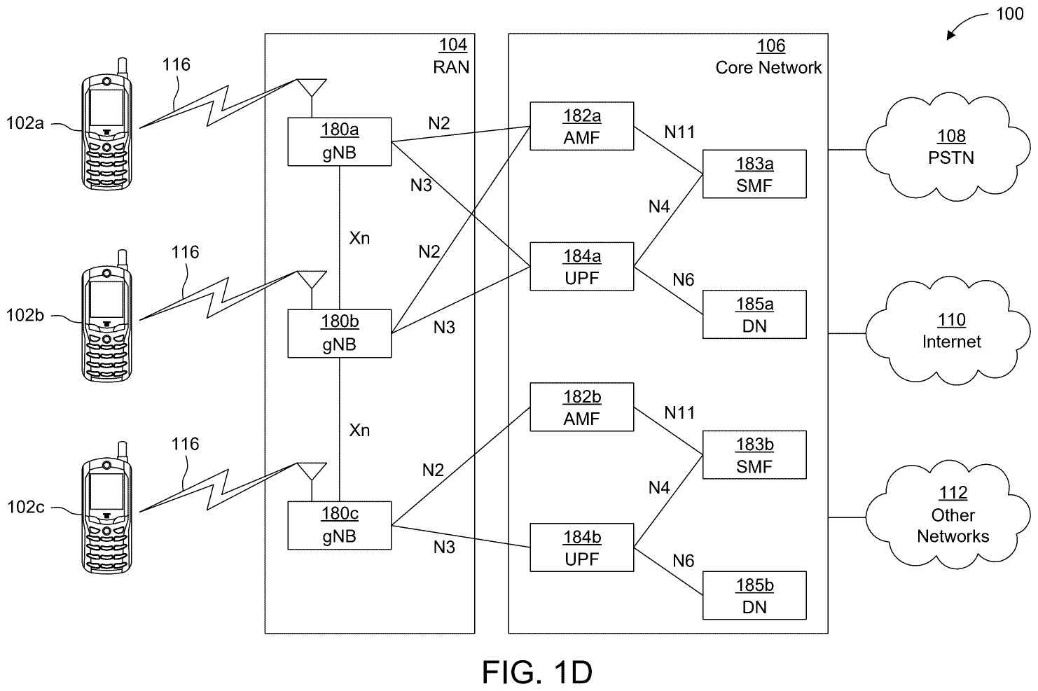

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a reader, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, a reader, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc”mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The terms device, IoT device, ambient Internet of Things (AIoT) device, IoT UE, AIoT UE, IoT WTRU, AIoT WTRU, and tag may be used interchangeably throughout this disclosure. The term device may refer to WTRU or UE, depending on the context and/or the topology. For example, the term device may refer to WTRU of UE when the WTRU or UE communicates with (e.g., being queried by) a reader. The term reader may refer to the entity which communicates with (e.g., queries) the IoT device, either directly, or via an intermediate/assisting node. The term reader may also refer to an intermediate/assisting node. As a result, the term reader may refer to BS, WTRU or UE that communicates with (e.g., queries) the IoT device, depending on the context and/or the topology. Throughout this disclosure, the terms reader, intermediate node, assisting node, intermediate UE, assisting UE, intermediate WTRU, assisting WTRU, UE, WTRU, BS, RAN, ambient RAN (A-RAN), and gNB may be used interchangeably.

IoT paging (e.g., AIoT paging) may refer to a communication mechanism used in IoT devices (e.g., AIoT devices), where devices periodically “wake up” or listen for signals from a network or a central controller to receive messages or commands. In the Access Stratum (AS) layer, the IoT paging (e.g., AIoT paging) functionality is to indicate device(s) that need to respond. As to the IoT paging (e.g., AIoT paging) message, an identifier may be required to identify the device/group of devices in this trigger message (e.g., for the case of reaching a single or a group of devices). When no identifier is present in the paging message, it may mean that all IoT devices (e.g., all AIoT devices) that have received the paging message need to respond.

The terms inventory, inventory procedure, IoT paging, AIoT paging, paging, and Initial trigger message may be used interchangeably throughout this disclosure.

IoT random access (RA) procedure (e.g., AIoT RA procedure) may refer to a process used by IoT devices (e.g., AIoT devices) to establish initial communication with a network, such as a cellular or wireless communication system. The IoT (or AIoT) random access may be triggered by a reader. It is supported to trigger access for a single device, group of devices, or all devices under the reader.

Ambient IoT device may be an IoT device powered by energy harvesting, with limited energy storage capability. The For example, AIoT devices may capture energy from ambient sources such as light (solar power), motion or vibrations (piezoelectricity), radio frequency (RF) signals, heat (thermoelectricity), or other natural environmental factors. Ambient IoT services may refer to the suite of functionalities and offerings provided by ambient power-enabled IoT systems that utilize environmental energy to power their operations. These services may support the communication, data collection, and processing needs of IoT devices that harvest energy from ambient sources such as light, vibrations, radio frequency (RF) signals, or thermal energy.

Device-originated-device-terminated triggered (DO-DTT) may refer to a communication pattern within IoT networks, particularly in the context of devices that operate with minimal power or intermittent connectivity, such as AIoT devices. Device-Originated (DO) may refer to a scenario where the IoT device initiates a communication or data transmission. This may happen, for example, when the device has collected sufficient data or harvested enough energy to send the information to a network node or another device. Device-Terminated Triggered (DTT) may refer to a scenario where the device receives a communication or trigger from another device or network component. In this case, the device “wakes up” or activates its functionality in response to an external signal or command. The device-originated traffic may be triggered by the device-terminated traffic or signaling. The device-terminated traffic may be terminated at the IoT device (e.g., AIoT device).

Ambient IoT Function (AIoTF) may refer to the functional capabilities and processes that enable AIoT devices to operate efficiently within IoT networks. This may be a 5G network function to support AIoT services. The AIoTF may be a standalone function or collocated with the AMF. is the AIoTF may be responsible for authentication and authorization of the AIoT devices, and routing of the UL/DL traffic between the AIoT devices and application function (AF) (e.g., via network exposure function (NEF)).

The IoT device (e.g., AIoT device) may initiate a random access (RA) procedure when it detects IoT paging (e.g., AIoT paging) or triggers that it might need to send information to the network. RA may refer to a procedure that is used by a device to gain initial access to a network after the device has had a period of inactivity. The TA procedure may be applied to any procedure that is used by the device to gain initial access to a network.

An IoT device (e.g., AIoT device) may perform a random access channel (RACH) procedure. Performing a RACH procedure may mean that the IoT device (e.g., AIoT device) may transmit a message to attempt to access the network. The IoT device (e.g., AIoT device) may determine if the RACH procedure is a success, if the IoT device (e.g., AIoT device) has gained access to the network. The IoT device (e.g., AIoT device) may determine that RACH is successful, or is not successful, based on receiving a message from the network. The success of the RACH procedure may mean that the IoT device (e.g., AIoT device) has successfully established communication with the network through the random access channel (RACH). The failure of the RACH procedure may mean that the IoT device (e.g., AIoT device) has not established communication with the network through the RACH. A broadcast message from a base station (BS) or reader is an example of an Access Stratum (AS) message.

An ambient power-enabled IoT device may be a type of IoT device that can harvest energy from the environment, such as wireless radio waves, motion, vibration, piezoelectricity, solar and wind power, and or the like. They may be either battery-less or have limited energy storage (e.g., using a capacitor). Ambient power-enabled IoT devices may often find their usage in industrial wireless sensor networks where the environment is harsh (e.g., extremely high or low temperature) and requires devices to be battery-less, maintenance-free, and long service life. They may also play an important role in smart logistics and smart warehousing. The low cost, small form factor, battery-lessness, and durability make them suitable to be attached to large amounts of goods and facilitate more efficient goods identifying, sorting, tracking, and inventory. In typical ambient power-enabled IoT use cases, AIoT devices are most likely involved in very small size data transmission/reception, such as sending device identifications, product information, sensor data, or receiving actuator commands, triggering messages, and or the like.

3GPP supports ambient IoT devices and use cases. The following architectural assumptions may be made: AIoT devices do not support RRC states, nor mobility or handover. The types of devices identified may be DT (Device-terminated), DO-DTT (Device-originated-device-terminated triggered), and DO-A (Device-originated-autonomous).

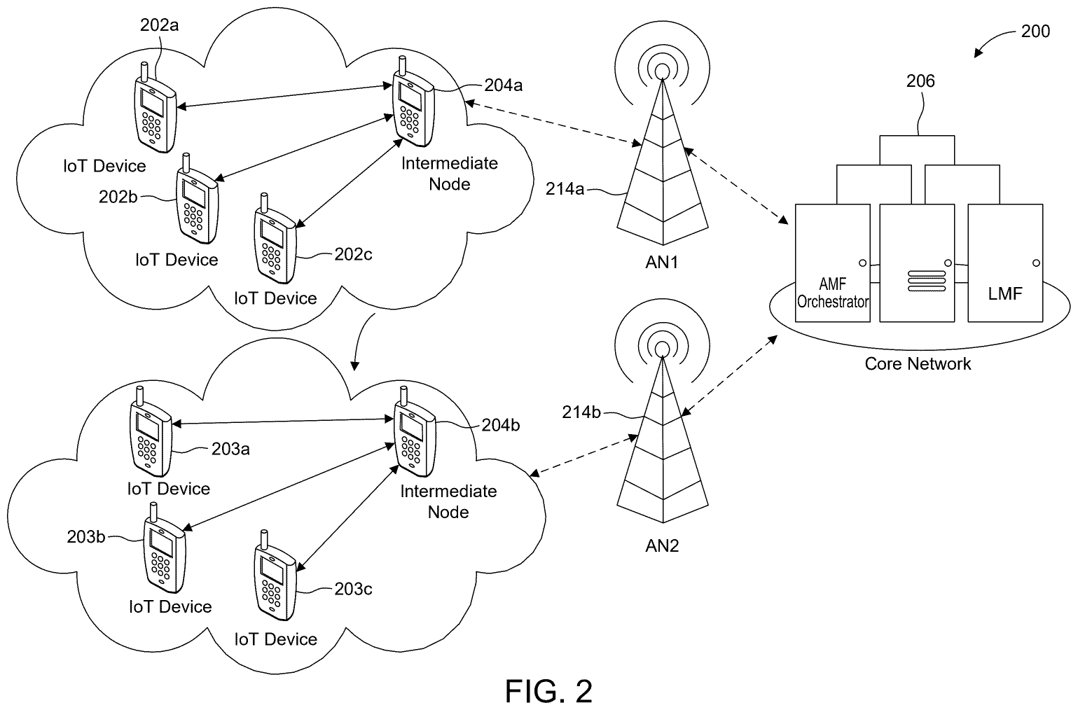

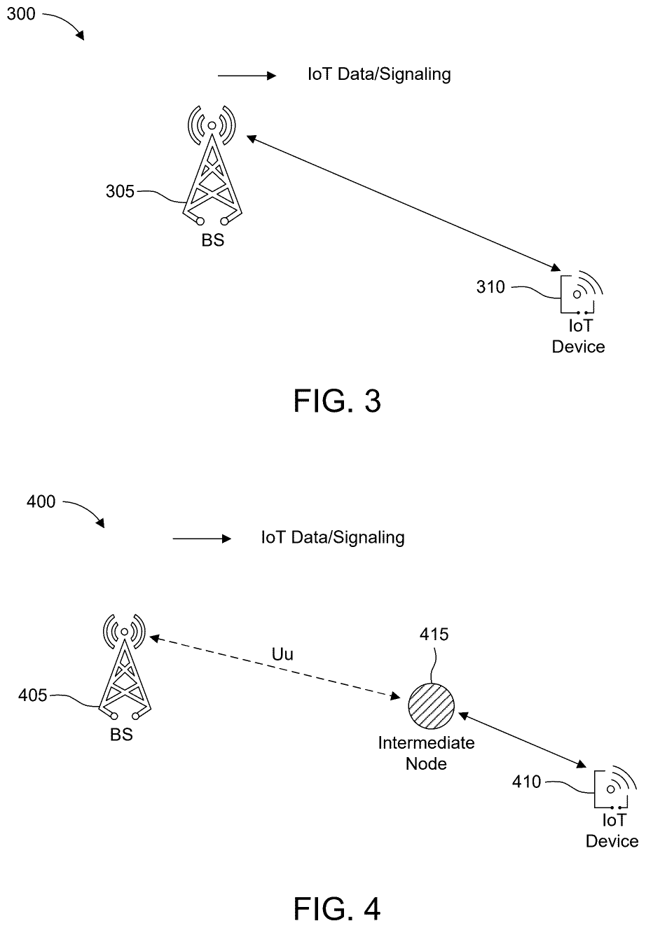

FIG. 2 illustrates an example network 200 where IoT devices 202a-c, 203a-c are located behind intermediate nodes 204a-b, which may be used in combination with any of other embodiments described herein. As illustrated in FIG. 3, the network 200 may use an intermediate node 204a-b to locate and page an ambient device(s) (e.g., IoT device(s) 202a-c, 203a-c, WTRU(s), UE(s)). The network 200 may use the intermediate node 204a-b to locate the IoT device 202a-c, 203a-c due to the limited power availability in the IoT device 202a-c, 203a-c and the possibility of the IoT device 202a-c, 203a-c becoming deactivated when the IoT device 202a-c, 203a-c runs out of power. For example, when the IoT device 202a-c, 203a-c becomes not pageable, the core network 206 can use the intermediate node 204-b location to locate the IoT device 202a-c, 203a-c via AN1 214a or AN2 214b.

The traffic types for IoT device may include, but are not limited to, device-terminated (DT, device-originated device-terminated triggered (DO-DTT) and the like. The communication spectrum may be assumed to be licensed. Handover may be not supported. RRC states may not be supported by IoT devices. No mobility (e.g., at least no cell selection/re-selection-like function) may be supported by IoT devices (e.g., AIoT devices).

FIGS. 3-6 illustrates example topologies 300, 400, 500, 550, 600, which may be used in combination with any of other embodiments described herein. For example, example topologies 300, 400, 500, 550, 600 described in FIGS. 3-6 may be used for IoT and/or AIoT devices.

FIG. 3 illustrates an example topology 300, which may be used in combination with any of other embodiments described herein. As illustrated in FIG. 3, an IoT device 310 may directly and/or bidirectionally communicate with a base station (BS) 305. The IoT device 310 may be any type of IoT device. The type of IoT device may include, but are not limited to, an ambient IoT device, a wearable device, a smart home device, an industrial IoT device, a healthcare IoT device, an environmental monitoring device, a smart city device, a connected vehicle, an agricultural IoT device, a smart grid device, and a consumer IoT device. The communication between the BS 305 and the IoT device 310 (e.g., ambient IoT device) may include IoT data and/or signaling (e.g., ambient IoT data and/or signaling). The topology 300 may include the possibility that the BS transmitting to the IoT device 310 is different from the BS receiving from the IoT device. In the topology 300, the BS 305 may be a reader, and the IoT device 310 may be a tag.

FIG. 4 illustrates an example topology 400, which may be used in combination with any of other embodiments described herein. As illustrated in FIG. 4, an IoT device 410 may communicate bidirectionally with an intermediate node 415 between the IoT device 410 and BS 405. The IoT device 410 may be any type of IoT device. The types of IoT device may include, but are not limited to, an ambient IoT device, a wearable device, a smart home device, an industrial IoT device, a healthcare IoT device, an environmental monitoring device, a smart city device, a connected vehicle, an agricultural IoT device, a smart grid device, and a consumer IoT device. In the topology 400, the intermediate node 415 may be a relay, an integrated access and backhaul (IAB) node, WTRU, UE, a repeater, or the like, which is capable of IoT communication. The intermediate node may transfer the information between the BS 405 and the IoT device 410. In the topology 400, the BS 405 and/or the intermedia node 415 (e.g., a relay or a repeater) may be a reader, and the IoT device 410 may be a tag.

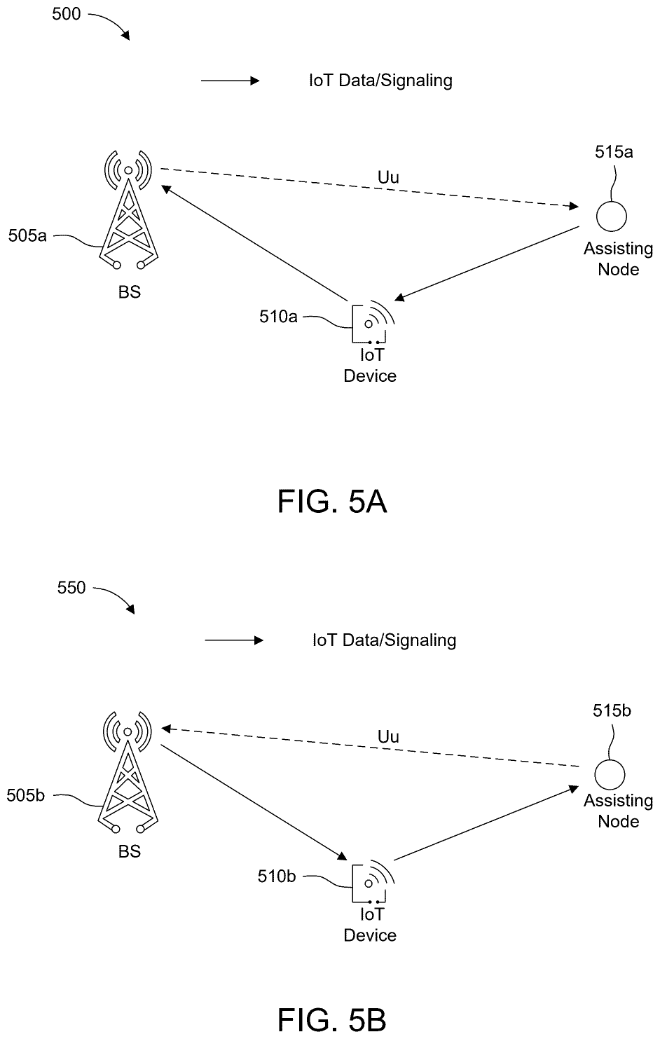

FIGS. 5A-B illustrate example topologies 500, 550, which may be used in combination with any of other embodiments described herein. As illustrated in FIG. 5A, an IoT device 510a may transmit data/signaling to a BS 505a and receive data/signaling from an assisting node 515a. As illustrated in FIG. 5B, an IoT device 510b may receive data/signaling from a BS 505b and transmit data/signaling to an assisting node 515b. The IoT devices 510a-b may be any type of IoT device. The types of IoT device may include, but are not limited to, an ambient IoT device, a wearable device, a smart home device, an industrial IoT device, a healthcare IoT device, an environmental monitoring device, a smart city device, a connected vehicle, an agricultural IoT device, a smart grid device, and a consumer IoT device. In the topologies 500, 550, the assisting nodes 515a-b may be a relay, IAB, WTRU, UE, a repeater, or the like, which is capable of IoT communication. In the topologies 500, 550, the BS 505a-b and/or the assisting node 515a-b (e.g., a repeater or a relay) may be a reader, and the IoT device 510a-b may be a tag.

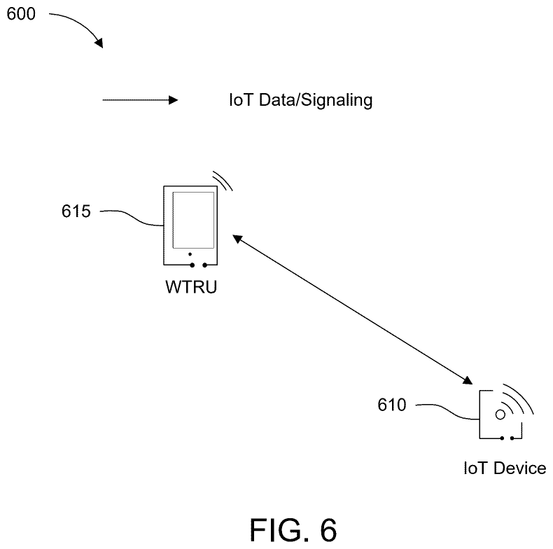

FIG. 6 illustrates an example topology 600, which may be used in combination with any of other embodiments described herein. As illustrated in FIG. 6, an IoT device 610 may communicate bidirectionally with a WTRU 615 (or UE). The IoT device 610 may be any type of IoT device. The type of IoT device may include, but are not limited to, an ambient IoT device, a wearable device, a smart home device, an industrial IoT device, a healthcare IoT device, an environmental monitoring device, a smart city device, a connected vehicle, an agricultural IoT device, a smart grid device, and a consumer IoT device. The communication between the WTRU 615 and the IoT device 610 may include IoT data and/or signaling (e.g., ambient IoT data and/or signaling). In the topology 600, the WTRU 615 (or UE) may be a reader, and the IoT device 610 may be a tag.

Paging and service requests are the mechanisms by which the network can alert a WTRU of incoming downlink data and for the WTRU to reactivate the uplink (UP) connection to receive the downlink (DL) data. The WTRU may be paged by the network (e.g., AMF) based on its intermediate temporary identifier 5G-GUTI using its shortened form 5G-S-TMSI. The temporary identifier may be uniquely assigned to the WTRU by the AMF and may serve to page to WTRU for all the PDU sessions the WTRU has. The WTRU may provide all the PDU Sessions whose connection can be re-activated in the service request message in response to the paging message. The network (e.g., SMF) may re-establish the UP connection for the PDU session in the list of PDU sessions for which pending DL data triggered the paging.

Early paging indication may be used to reduce the power consumption in the WTRU by using the early paging indication. An early paging indicator (EPI) may be sent to the WTRU over downlink control information (DCI) or the reference signal. Thus, the WTRU may check the next paging occasion (PO) for paging instead of decoding every PO sent during the waking time. When the EPI is received by the WTRU, the WTRU may be ready to decode the next received PO.

Sub-grouping on paging may be used to reduce the false paging notification rate as a wide range of WTRUs has the same PO or a group of inactive WTRUs has the same EPI, this can reduce the power consumption in the UE. The sub-group information is sent alongside the enhanced packet information (EPI) over DCI, where the WTRU group is divided into subgroups. This may allow the WTRU to figure out if to decode the next PO.

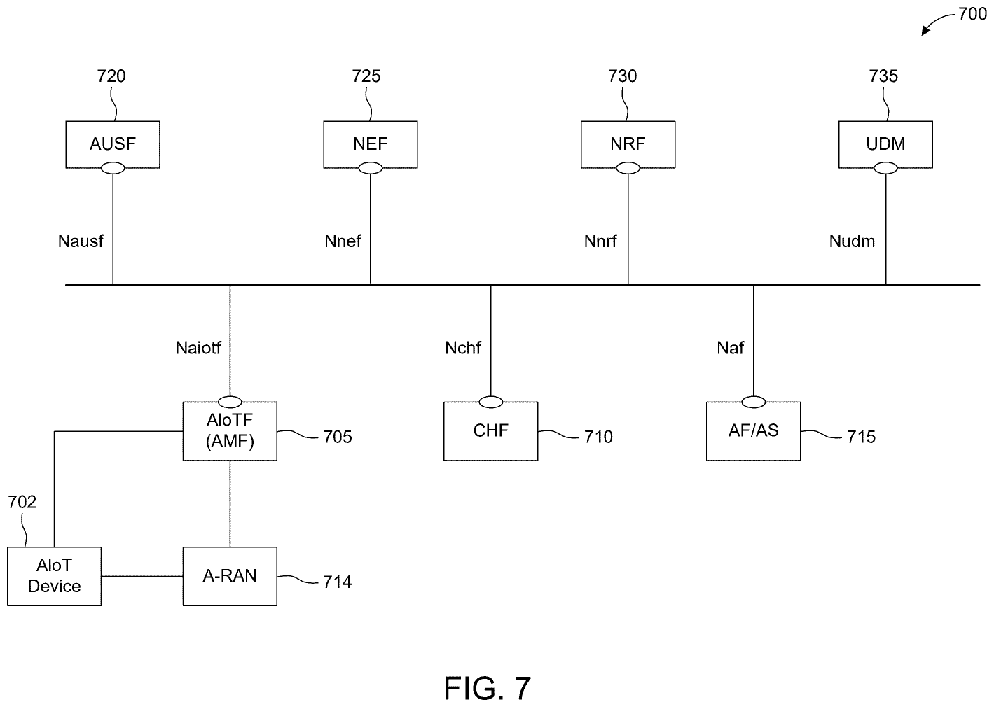

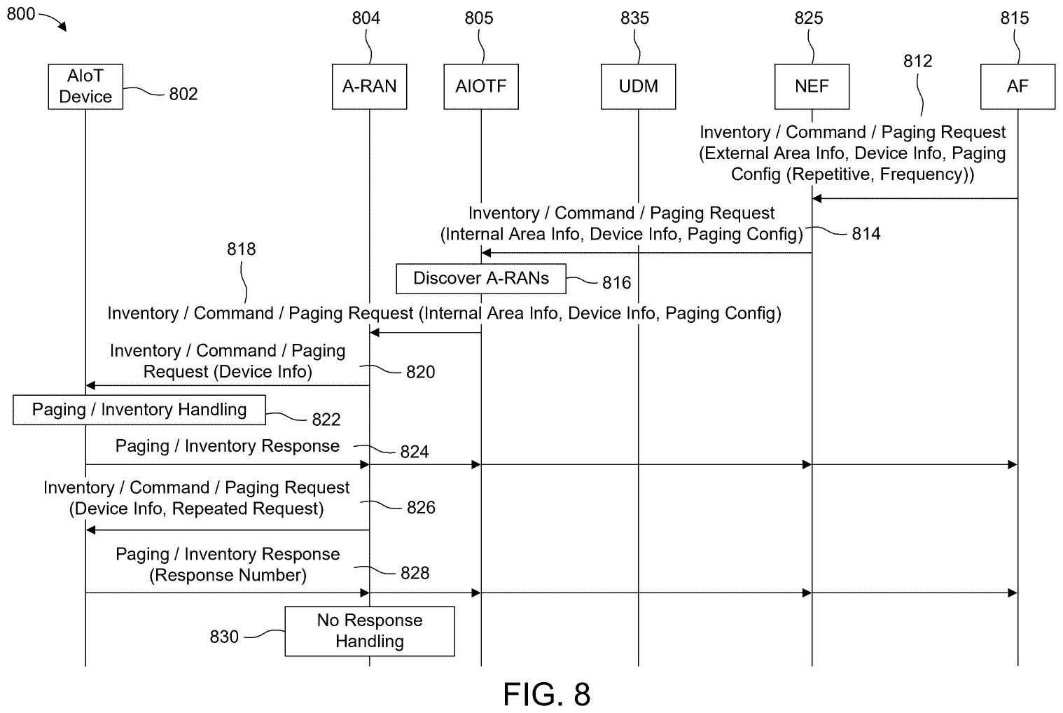

FIG. 7 illustrates example architecture 700 to support AIoT devices and services, which may be used in combination with any of other embodiments described herein. As illustrated in FIG. 7. As illustrated in FIG. 7, the example architecture 700 (e.g., 5GS architecture) may include, but are not limited to, AIoT device 702, A-RAN 714, AIoTF (e.g., AMF) 705, charging function (CHF) 710, application function/application server (AF/AS) 715, authentication server function (AUSF) 720, network exposure function (NEF) 725, network repository function (NRF) 730, and unified data management (UDM) 735. to the AIoT 705 may support AIoT services, with some AMF functionalities integrated. Such AMF functionalities may include, but are not limited to, Ambient IoT RAN (A-RAN) connectivity, inventory (e.g., paging) handling and device context management, authentication and authorization for the access, which triggers interaction with AUSF 720 or UDM 735, collect charging data and interact with CHF 710 for charging, routing the request from AF 715 (via NEF 725) to A-RAN 714, for DO-DTT/DT traffic types, and routing the response from A-RAN 714 to AF 715 (via NEF 725) for DO-DTT traffic type.

The UDM 735 may store and manage the AIoT device information. The AIoT device information may comprise the device ID, device status information (e.g., enabled/disabled/permanently disabled), core network (CN) related information (e.g., serving NF) and/or the like. The NEF 725 may expose IoT-specific services or AIoT-specific services to AF 715. The CHF 710 may manage charging information for IoT services (e.g., AIoT services). The NRF 730 may support the new NF type AIoTF and the corresponding NF profile. The AUSF 720 may be responsible for the authentication for the access from AIoT devices.

The paging or inventory procedure may be triggered by an application function (AF) 715 by sending an inventory request to CN. The CN may send a request to A-RAN 714. The AIoT devices 702 may respond to the paging or inventory request from the A-RAN 714 and send their device IDs and additional information if requested via the paging/inventory/command procedure.

The AF 715 may further provide the inventory strategy information (e.g., inventory frequency, inventory period, and/or the like) to enable CN or A-RAN 714 to perform periodic inventory to allow the newly coming AIoT devices 702 to be discovered, without further explicit requests from the AF 715.

The AMF (e.g., AIoTF) may provide paging attempt information to RAN, A-RAN or NG-RAN. The paging attempt information may include an intended number of paging attempts value.

AIoT paging or initial trigger message may be used to trigger a single device, a group of devices using a group ID or multiple devices with separate IDs, or all devices in the coverage area to respond for inventory and/or command use cases. A paging message for AIoT devices can also be considered a type of an inventory request for all devices, a group of devices, or a single device.

As described above, an AIoT device is a type of IoT device that can harvest energy from the environment, such as wireless radio waves, motion, vibration, piezoelectricity, solar and wind power, or the like. They may be either battery-less or have limited energy storage (e.g., using a capacitor). It may be assumed that the duration of the AIoT devices'unavailability due to charging by energy harvesting may be up to several tens of seconds, since different types of AIoT devices are to be supported by the IoT system. The charging time for the AIoT devices to start or resume AIoT communications may vary.

This characteristic of the AIoT devices (e.g., in terms of sporadic and hard to predict availability due to power restrictions) and the AIoT system poses a situation in that some of these devices might not be available for the AIoT reception/transmission procedures. For example, AIoT paging procedure or paging message (e.g., inventory, command, or inventory+command) may be missed by some AIoT devices because of the power consumption or charging duration needed for the AIoT devices to be able to establish communication with the ambient IoT reader. It is also possible that the AIoT device response is not received by the reader or the reader fails to decode the device response because of limited communication range, device mobility, or interference. Furthermore the lack of the network (e.g. AIoTF), AF awareness with respect to the AIoT devices actual availability may lead to inefficiencies when applying conventional paging strategies (e.g., for regular WTRUs) that may be ill-suited for AIoT devices. Thus, methods and apparatuses that handles the AIoT device availability for transmission and reception procedures while taking into consideration operational efficiency for all involved entities of the network system may be needed.

As described above, the unavailability of the AIoT devices for the AIoT reception/transmission procedures may lead to the failure of certain procedures within the AIoT system. For example, AIoT paging procedure (e.g., inventory, command, or inventory+command) may be missed by some AIoT devices because of the power consumption or charging duration needed for the AIoT devices to be able to establish communication with the AIoT reader and other network functions of the AIoT system. Paging configuration provided by the AF or CN (e.g., AIoTF) to the A-RAN reader may be used to assist the A-RAN readers to configure their paging/inventory/command procedures accordingly for the AIoT devices. For example, in a scenario where response needs to be ensured from the AIoT device, the A-RAN reader may configure its paging procedure to include paging retransmissions, the paging retransmission times, frequency, and duration as per the received paging configuration from the AF. The paging retransmission may ensure that the AIoT device will receive paging, or the device response will be successfully received by the reader when it can establish communication with the A-RAN reader (i.e., it has harvested enough energy to establish communication with the AIoT system (e.g., reader)). In case that there was no response to the paging retransmission messages from the AIoT device, the A-RAN reader may construct a report that includes the number of paging retransmission attempts, time frame, device information, and area information. The A-RAN reader may provide the report to the AF via 5GS (e.g., AIoTF). The report may be used by the AF to determine if the AIoT device is no longer available, has died, or relocated to a different area.

FIG. 8 illustrates an example signal flow 800, for handling IoT device availability for IoT transmission and reception procedures (e.g., inventory, command, inventory+command), which may be used in combination with any of other embodiments described herein. At 812, an application function (AF) 815 may send an Inventory/command/paging message or request to an NEF 825. The inventory/command/paging message request may comprise area information such as geographical area information, device information, paging configuration information, and/or the like. The device information may comprise a device ID, multiple device IDs, device group ID, an indication that all or some devices should be paged, and/or the like. The paging configuration information may have the information about how the paging procedure needs to be carried out by the one or more readers. The paging configuration information may include, but is not limited to: an indication/instruction that paging retransmission is not required (e.g., best effort approach), an indication/instruction that paging retransmission is required, and an indication/instruction that paging retransmission is required but conditional. The paging configuration information that includes the indication/instruction that paging retransmission is required may further include a number of retransmission attempts, a frequency for the paging retransmission, a duration of paging retransmission. The duration of paging retransmission may be defined as a time value or a time period.

The paging configuration information that includes the indication/instruction that paging retransmission is required but conditional may further include conditional information indicative of one or more criteria that trigger the paging retransmission. The one or more criteria that trigger the paging retransmission may include, but are not limited to, a threshold, the importance of time, the importance of location, a device ID, and a group ID. The threshold may be a value, a percentage, a number, a time threshold, a period of time, a location, battery status, battery power, RSSI, SNR, and/or the like. For example, received responses from the devices are below a certain threshold, a reader (e.g., A-RAN 804) may retransmit the inventory/command/paging message request to the devices, the group of devices, or all of the devices. In one example, the threshold is 80% and it is required that more than 80% of the devices shall respond to the paging/command/inventory message or request. If less than 80% of the devices responded to the paging/command/inventory message or request, the reader (e.g., A-RAN 804) may retransmit the paging/command/inventory message or request to the devices, the group of devices, or all of the devices. The retransmission may be unicast, multicast, or broadcast. The AF 815 may be provided with the number of devices that would be paged, to assist in the calculation of the expected response/percentage/threshold values. When the paging/command/inventory message or request is time-critical, a paging response may need to be ensured within a certain time frame. When the request is location-critical, a paging response may need to be ensured within a given time frame and location information.

The paging configuration information that includes the indication/instruction that paging retransmission is required but conditional may further include a number of retransmission attempts, a frequency for the paging retransmission, and/or a duration of paging retransmission. The duration of paging retransmission may be defined as a time value or a time period.

The duration of the paging configuration information or paging retransmission information may be a duration value and may be determined based on the type of device(s) that are being paged. For example, the devices that are being paged may harvest energy from the paging signaling or may harvest energy while the paging signal is transmitted. The duration value may be set to indicate to the A-RAN 804 how long the paging message needs to be transmitted so that the AIoT device 802 may harvest energy for a long enough time so that the AIoT device 802 may have enough energy stored to respond to the paging message.

Alternatively or additionally, the AF 815 may not directly provide the paging configuration, but may provide an indication of the level of criticality of the current request. A higher level of criticality means that the successful device response should be ensured or guaranteed, and the network/reader may determine to perform paging retransmissions. A lower level of criticality means that the device response is expected but it is also acceptable to not receive the response, and the network/reader may determine to take a best-effort approach and not perform paging retransmissions. The CN (e.g., AIoTF 805) may make the paging strategy and paging configuration information based on this indication of level of criticality, as described in 816.

It is also possible that the AIoTF 804 may forward the level of criticality indication to the reader or the A-RAN 804, and the reader or the A-RAN 804 may determine/generate paging strategies (whether and how to perform paging retransmissions) or paging configuration information on its own.

At 804, the NEF 825 may authorize the request from the AF 815. The NEF 825 may perform the translation of the area information (e.g., external area information) provided by the AF 825 into the internal area (e.g., TAIs and/or Cell IDs). Accordingly, based on the internal area information, the NEF may determine the AIoTFs 805 serving the area. The NEF 825 may send the inventory/command/paging message or request to the determined AIoTFs 805 along with the internal area information, device information, and paging configuration information. In other words, the NEF 825 may determine which AIoTFs can be used to communicate in the area that is defined by the area information received at 812.

At 816, the AIoTF 805 may discover A-RANs 804 based on the internal area information provided by the NEF 825. Discovering A-RANs means determining which A-RANs can be used to communicate in the area that the NEF 825 indicates the paging message or request needs to be sent to. If an indication of the level of criticality is included in the paging message or request as described at 812, the AIoTF 804 may determine/generate the paging configuration information based on the indication and provide it to the reader or the A-RAN 804. The content of the paging configuration information may be the same or similar as described at 812.

At 818, the AIoTF 805 may send an NGAP message (e.g., inventory/command/paging message or request) to the A-RANs 804 with the internal area information, device information, and paging configuration information. The device information may be a device ID, multiple device IDs, device group ID, and/or an indication that all or some devices should be paged along with the paging configuration information received from the AF 815. The AIoTF 805 may also provide the paging configuration information or the level of criticality indication to the A-RANs 804 as described at 812.

At 820, the A-RAN 804 or a reader may initiate an inventory/command/paging procedure based on the device information. For example, the paging message may include an indication that the paging message targets all devices. For example, the paging message may include a group identifier that indicates that the paging message targets all groups of devices. For example, the paging message may include an identifier and a mask, and thus indicate that the paging message targets all devices whose device identifier matches at least part of the identifier that is in the paging message.

If a level of criticality indication is received at 818, the A-RAN 804 may determine/generate a paging strategy and/or paging configuration information based on the A-RAN implementation.

The A-RAN 804 may broadcast the paging message for a length of time, and the time duration may be determined based on the duration of the paging configuration information or paging retransmission information received at 814.

The A-RAN 804 may include a message identifier in the paging message and a retransmission indicator. When the A-RAN 804 transmits a paging message for the first time, the paging message may include a message identifier and an indicator that the paging message is an initial transmission. When the A-RAN 804 retransmits a paging message for the first time, the paging message retransmitted may include the same message identifier and a retransmission indicator.

When a paging message is a retransmission, the A-RAN 804 may include both a list of identifier(s) in the paging message that identify devices that should not respond to the paging message and a list of identifier(s) in the paging message that identifies devices that should respond to the paging message. For example, the paging message may indicate that all devices or a group of devices should respond to the paging message, and that certain devices, which are part of the group or included in “all devices” group, should not respond to the paging message. The devices that A-RAN 804 indicates should not respond to the paging message may be devices that the A-RAN 804 already received a response from.

At 822, the AIoT device 802 may determine whether to respond to the paging message received from the A-RAN 804 or the reader, based on its transmission capabilities. For example, if the AIoT device 802 has enough power to respond to the paging message, or its harvesting energy at the moment, the AIoT device 802 may not have transmission capabilities. If the AIoT device 802 does not have enough power or is harvesting energy, the AIoT device 802 may ignore the paging message or choose to not respond to the paging message.

If the AIoT device 802 detects, based on the message identifier and the indication of whether or not the message is a retransmission, that the AIoT device 802 already responded to the paging message, then the AIoT device 802 may determine to not respond to the paging message.

If the AIoT device 802 detects that it is part of the group that the paging message indicates should respond but the paging message also indicates that the AIoT device should not respond, the AIoT device 802 may determine that it has already responded to an earlier transmission of the request and determine to not respond to the paging message. A benefit of including a list of devices that do not need to respond to the request is that the AIoT devices 802 does not need to remember, or store, information about previous responses to paging messages.

At 824, if the AIoT device 802 responds to the paging message or request from the A-RAN 804 or the reader, the response may be sent to the AF 815 via the network nodes or network components such as the A-RAN 804 (or the reader), AIoTF 805, and NEF 825. The response may include inventory information. For example, the response may include an identifier of the AIoT device 802 so that the network is aware of the AIoT device's inventory. Being aware of the AIoT device's inventory means that the network is aware of the AIoT device's presence in the network. The response may also include application-specific data such as AIoT device state information, a sensor reading, and/or the like.

At 826, the A-RAN 804 may send paging retransmission. For example, when there was no response at 824 received from the AIoT device 802 or the response from the AIoT device 802 did not reach the A-RAN 804 or the reader, as per the paging configuration received from the CN or made by the A-RAN 804 itself, the A-RAN 804 may be configured to support paging retransmission. The A-RAN 804 or the reader may initiate retransmission of the inventory/command/paging message with additional information. For example, the additional information may include an indication indicative of repeated paging or repeated request. The additional information/flag/indication indicative of the repeated paging or repeated request may assist the AIoT devices 802 to know that this is the retransmission of the earlier paging message from the A-RAN 804 or the reader. The A-RAN 804 or the reader may determine the retransmission attempts, frequency, and duration of retransmissions based on the paging configuration information received from the AF 815.

At 828, the AIoT device 802 may respond to the request from the A-RAN 804 or the reader. The response may be sent to the AF 815 via the network nodes or network components such as the A-RAN 804 (or the reader), AIoTF 805, and NEF 825. As this paging message or request (e.g., at 826) was retransmission from the A-RAN 804 or the reader (i.e., the paging message or request includes the repeated paging indication/flag), the AIoT device 802 may include additional information in the paging response about a paging response number or order. The paging response number may indicate the iteration number corresponding to the paging response sent by the AIoT device 802. For example, the AIoT device 802 already sent a paging response (i.e., the first paging response) at 824, but the paging response was not reached to the A-RAN 804. Once the AIoT device 802 received, from the A-RAN 804 or the reader, the retransmission of the paging message at 826, the AIoT device 802 may send the paging response again with the indication of a second transmission (i.e., the second paging response with response number 2). The paging response may include a list of time stamps indicative of when the paging response was sent by the AIoT device 802. This additional information on the paging response number or the list of time stamps, when the paging was responded to by the AIoT device 802, may assist the A-RAN 804 or the network node such as the AF 815 in determining whether earlier paging responses were lost. The A-RAN 804 or the network node such as the AF 815 may aggregate the response data from multiple AIoT devices to determine radio conditions of a particular area or device status of the AIoT device 802 or a group of devices. Alternatively or additionally, the A-RAN 804 or the network node such as the AF 815 may use the additional information further for data analysis.

At 830, in case that there was no response by the AIoT device 802 to the paging retransmission messages sent from the A-RAN 804 or the reader, the A-RAN 804 or the reader may construct a report which may include a number of paging retransmission attempts, a time frame, device and area information, and/or the like. The A-RAN 804 or the reader may provide this report to the AF 815 via 5GS (e.g., AIoTF 805 and/or NEF 825). The report may be used by the AF 815 to determine if the AIoT device 802 or the group of devices associated with the AIoT device 802 is no longer available, has died, or relocated to a different area.

The above procedure uses the A-RAN 804 (e.g., BS, or reader) as an example. A similar procedure may also apply when a WTRU reader, or UE reader (e.g., an intermediate node) is handling the AIoT service. The AIoTF 805 may provide similar paging configuration information to the WTRU reader or UE reader (e.g., an intermediate node) and the WTRU reader or UE Reader may perform AIoT paging retransmissions based on the paging configuration information.

In one embodiment, the AF 815 may provide paging assistance configuration information prior to sending an inventory/command/paging message request. For example, the AF 815 may send a dedicated configuration (e.g., create) request message to the AIoTF 805 via the NEF 825 (e.g., at 812) and receives an acknowledgment from the AIoTF 805 via the NEF 825. The acknowledgement may include a paging configuration information network reference corresponding to the received paging assistance configuration information. The paging configuration information network reference may identify the paging assistance configuration information stored locally within a network node (e.g., the AIoTF 805). The configuration request message may apply to one or more AIoT devices. The AIoTF 805 and/or A-RAN 804 may store the paging configuration information associated with the devices and with the paging configuration information network reference. The AF 815 may send an inventory/command/paging message request that may include one or more AIoT devices and a paging configuration information network reference. The AIoTF 805 and/or A-RAN 804 may locate the paging configuration information based on the received devices information and/or paging configuration information network reference. If the paging configuration information is not found, the AIoTF 805 and/or A-RAN 804 may reject the inventory/command/paging message request of the AF 815 with a cause code indicating missing paging configuration information for the one or more devices. If the paging configuration information is found, the AIoTF 805 and/or A-RAN 804 may proceed with the paging procedure as described above based on the paging assistance configuration information. The AF 815 may update the paging assistance configuration information based on detected AIoT devices availability pattern (e.g., using paging response frequency, success rate during the inventory/command/paging procedure). The AF 815 may provide an updated assistance configuration information in a dedicated configuration (e.g., update) request message to the AIoTF 805 via the NEF 825, providing the network configuration reference. The AIoTF 805 and/or A-RAN 804 may update the configuration accordingly. As a result of the updated paging assistance configuration information, the AIoTF 805 and/or A-RAN 804 may decide to abort an ongoing paging procedure that uses an old paging assistance configuration information.

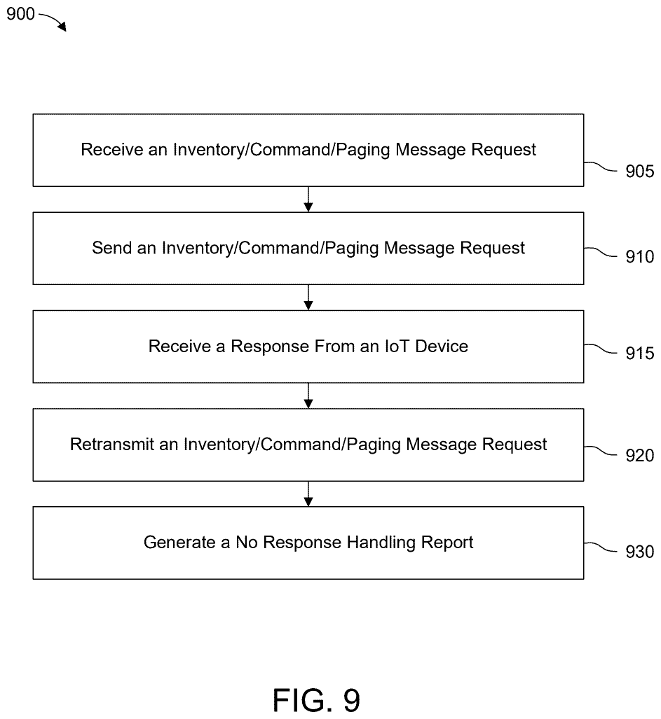

FIG. 9 illustrates an example procedure 900 for paring retransmission, which may be used in combination with any of other embodiments described herein. At 905, a reader (e.g., AIoT reader, A-RAN, RAN, UE, or WTRU) may receive a message (e.g., inventory/command/paging message request) from a network node such as AIoTF. The message may include, but is not limited to, internal area information, device information, and paging configuration information. The device information may be a device ID, multiple device IDs, device group ID, and/or an indication that all devices should be paged. The paging configuration information may include, but is not limited to: an indication/instruction that paging retransmission is not required (e.g., best effort approach), an indication/instruction that paging retransmission is required, and an indication/instruction that paging retransmission is required but conditional.

The paging configuration information that includes the indication/instruction that paging retransmission is required may include a number of retransmission attempts, a frequency for the paging retransmission, a duration of paging retransmission. The duration of paging retransmission may be defined as a time value or a time period.

The paging configuration information that includes the indication/instruction that paging retransmission is required but conditional may include conditional information indicative of one or more criteria that trigger the paging retransmission. The one or more criteria that trigger the paging retransmission may include, but are not limited to, a threshold, the importance of time, the importance of location, a device ID, and a group ID. The threshold may be a value, a percentage, a number, a time threshold, a location threshold, battery power, RSSI, SNR, and/or the like. For example, received responses from the devices are below a certain threshold, a reader (e.g., A-RAN) may retransmit the inventory/command/paging message request to the devices, the group of devices, or all of the devices. For example, the threshold is 80% and it is required that more than 80% of the devices shall respond to the paging/command/inventory message or request. If less than 80% of the devices responded to the paging/command/inventory message request, the reader (e.g., A-RAN) may retransmit the paging/command/inventory message request to the devices, the group of devices, or all of the devices. The retransmission may be unicast, multicast, or broadcast. The AF 815 may be provided with the number of devices that would be paged, to assist in the calculation of the expected response/percentage/threshold values. When the paging/command/inventory message or request is time critical, a paging response may need to be ensured within a certain time frame. When the request is location critical, a paging response may need to be ensured within a given time frame and location information.

The paging configuration information that includes the indication/instruction that paging retransmission is required but conditional may further include a number of retransmission attempts, a frequency for the paging retransmission, and/or a duration of paging retransmission. The duration of paging retransmission may be defined as a time value or a time period.

At 910, the reader (e.g., A-RAN) may initiate an inventory/command/paging procedure based on the device information. For example, the reader may send an inventory/command/paging message request to the IoT device, a group of IoT device, and/or all of the IoT devices. For example, the paging message may include an indication that the paging message targets all devices. For example, the paging message may include a group identifier that indicates that the paging message targets all groups of devices. For example, the paging message may include an identifier and a mask, and thus indicate that the paging message targets all devices whose device identifier matches at least part of the identifier that is in the paging message

At 915, the reader (e.g., A-RAN) may receive one or more responses or no responses. For example, if the IoT device responds to the paging message received from the reader, the reader may relay the response to the AF via AIoTF and NEF. The response may include inventory information. For example, the response may include an identifier of the IoT device so that the network may know the IoT device's inventory. Being aware of the IoT device's inventory means that the network is aware of the IoT device's presence in the network. The response may also include application-specific data such as AIoT device state information, a sensor reading, and/or the like.

At 920, the reader (e.g., A-RAN) may retransmit the inventory/command/paging message request to the IoT device, the group of IoT devices, and/or all of the IoT devices. For example, when the reader receives no responses from the IoT device or the response from the IoT device did not reach the reader, as per the paging configuration received from the CN (e.g., AF) or made by the reader, the reader may be configured to support paging retransmission. The reader may initiate retransmission of the inventory/command/paging message request with additional information. For example, the additional information may include an indication indicative of repeated paging or repeated request. The additional information/flag/indication indicative of the repeated paging or repeated request may assist the IoT devices to know that this is the retransmission of the earlier paging message from the reader. The reader may determine the retransmission attempts, frequency, and duration of retransmissions based on the paging configuration information received from the CN (e.g., AF).

The paging message retransmission may indicate that a list of devices (e.g., a group of devices or all devices) that should respond and also include a list of devices that should not respond. The list of devices that should not respond may be part of the group and may be the devices that are already responded. The list of devices that should respond may be part of the group and may be the devices that did not respond or responded but the response did not reach to the reader.

At 930, in case that the reader (e.g., A-RAN) received no responses from the IoT device the group of IoT devices, or all of the IoT devices, the reader may construct a report which may include a number of paging retransmission attempts, a time frame, device and area information, and/or the like. The reader may provide this report to the AF via the AIoTF and the NEF. The report may be used by the CN (e.g., AF) to determine if the IoT device or the group of devices associated with the IoT device is no longer available, has died, or relocated to a different area.

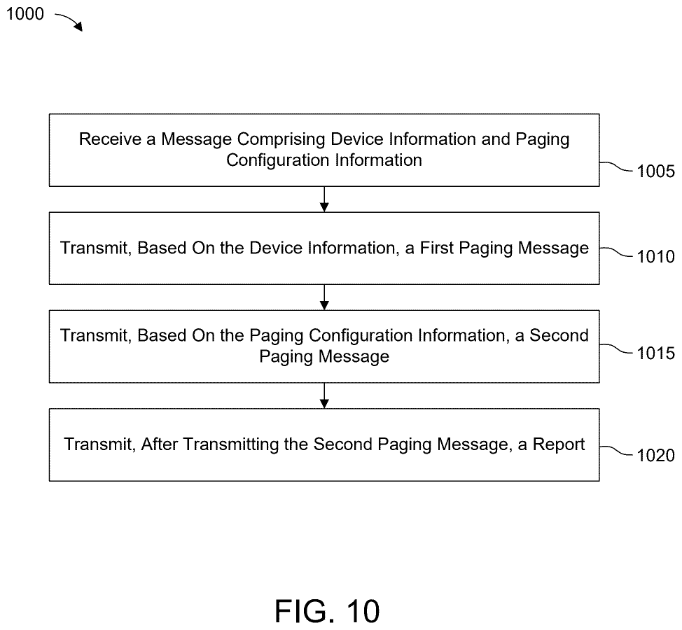

FIG. 10 illustrates an example procedure 1000 for paring retransmission, which may be used in combination with any of other embodiments described herein. At 1005, a WTRU may receive a message from a network node. The WTRU may be an entity which communicates with (e.g., queries) an IoT device, either directly, or via an intermediate/assisting node. The WTRU reader may also be an intermediate/assisting node. The WTRU may refer to a reader, BS, or UE that communicates with (e.g., queries) the IoT device. The WTRU may also refer to an intermediate node, an assisting node, an intermediate UE, an assisting UE, an intermediate WTRU, an assisting WTRU, RAN, ambient RAN (A-RAN), gNB, and/or the like. The network node may comprise at least one of RAN, A-RAN, IoTF, AIoTF, AMF, CHF, AF, AS, AUSF, NEF, NRF, or UDM.

The message received from the network node may comprise device information and paging configuration information. The device information may comprise a device identity, multiple device identities, a device group identity, an indication that all or some devices should be paged or not, and/or the like. The device may be an IoT device, ambient AIoT device, IoT UE, AIoT UE, IoT WTRU, AIoT WTRU, tag or the like. The device may refer to WTRU or UE, depending on the context and/or the topology. For example, the device may refer to WTRU of UE when the WTRU or UE communicates with (e.g., being queried by) a reader.

The paging configuration information may include paging retransmission instructions. The paging retransmission instructions may comprise a first instruction indicative of retransmission not required, a second instruction indicative of retransmission required, and a third instruction indicative of conditional retransmission required. The paging configuration information with the second instruction may comprise a number of retransmission attempts, a frequency for paging retransmission, and a duration of paging retransmission. The paging configuration information with the third instruction may comprise a threshold, a number of retransmission attempts, a frequency for paging retransmission, and a duration of paging retransmission. The threshold may be a value, a percentage, a number, a time threshold, a period of time, a location, battery status, battery power, RSSI, SNR, and/or the like.

At 1010, the WTRU may transmit a first paging message to a group of devices. For example, the WTRU may transmit, based on the device information, the first paging message to the group of devices. The first paging message may comprise an inventory request, a command, and an inventory request with a command. The first paging message may be multicast or broadcast to the group of devices based on the device identifier. For example, the device identity may be a single device identity, multiple device identity, a group device identity, and/or an identity that equates to all devices.

At 1015, the WTRU may transmit, based on the paging retransmission instructions, a second paging message. For example, on a condition that one or more paging responses are received or no responses are received, the WTRU may transmit, based on the paging retransmission instructions, the second paging message. The second paging message may comprise an inventory request, a command, and an inventory request with a command. The second paging message may further comprise an indication of paging retransmission. In case that the one more paging responses are received from one or more devices of the group of devices, the WTRU may transmit the second paging message based on the paging configuration information with the third instructions indicative of conditional retransmission required. For example, the WRU may determine whether the number of the one or more paging responses received is less than the threshold. The WTRU may transmitting, based on that the number of the one or more paging responses received is less than the threshold, the second paging message with the indication of paging retransmission. For example, the threshold may be 80% and it is required that more than 80% of the devices shall respond to the first paging message. If less than 80% of the devices responded to the first paging message, the WTRU may transmit the second paging message to the group of devices. The retransmission of the second paging message may be multicast or broadcast. In one example, the threshold (e.g., 80% of the responses) may be used with a duration or a time period. For example, if more than 80% of the responses are received but not within the duration or the time period, the WTRU may transmit the second paging message to the group of devices. In another example, the threshold may be a time threshold, a time period, or a timer. For example, if no responses are received within the time threshold (e.g., the timer expired), the WTRU may transmit the second paging message to the group of devices.

The second paging message may include one or more identifiers associated with one or more devices that are not to respond to the second paging message. It is because the WTRU already received the one or more paging responses to the first paging message from the one or more devices of the group of devices. For example, the second paging message may include a list of device identifiers of devices that should not respond to the second paging message. The list of device identifiers of devices that should not respond to the second paging message may identify the devices that responded to the first paging message.

After transmitting the second paging message with the indication of paging retransmission at 1015, the WTRU may receive one or more paging responses from one or more devices associated with the group of devices. The one or more paging responses received may include one or more response numbers associated with the respective one or more paging responses. The one or more response numbers may indicate the iteration number corresponding to the paging response sent by the device. For example, a device already sent a paging response (i.e., the first paging response) to the WTRU in response to the first paging message, but the paging response (i.e., the first paging response) was not reached to the WTRU. Once the device received the second paging message from the WTRU, the device may send the paging response (i.e., second paging response) again with the indication of a second transmission (i.e., the second paging response with response number 2).

However, in case that no paging responses are received from the group of devices after the WTRU transmitted the second paging message with the indication of paging retransmission, the WTRU may transmit, to the network node, a report such as a no response handling report at 1020. Such a report may include or indicate a number of paging retransmission attempts, a time frame, device information associated with the group of devices, area information associated with the group of devices and/or the like. The WTRU may send this report to the network node (e.g., AF) via 5GS (e.g., AIoTF and/or NEF). The report may be used by the network node (e.g., AF) to determine if one or more devices or the group of devices associated with the one or more device are no longer available, have died, or relocated to a different area.

An IoT device (e.g., AIoT device) may detect if a paging message is a duplicate transmission based on information in the paging message. For example, the IoT device may detect that the content of the paging message is identical to the paging message that the IoT deice last received or recently received. Alternatively or additionally, the IoT device may detect that a message identifier in the paging message is identical to the paging message that the IoT device last received or recently received. A drawback of these approaches may be that the IoT device may need to remember, or store in memory, all or some of the information from a paging request message.

As above, a first paging message may include a group identifier that indicates to the WTRU that all devices associated with the group of devices should respond to the paging request. Alternatively of additionally, a first paging message may include an indication that indicates to the WTRU that all devices that receive the paging message should respond to the paging message.

After the WTRU (e.g., a reader or A-RAN) receives one or more responses from one or more devices, the WTRU may determine that the paging message needs to be retransmitted because not all devices from the group responded or not enough devices responded. The WTRU may then send a second paging message. The second paging message may include the same group identifier as the first paging message in order to indicate that all devices that are part of the group should respond to the paging message. Alternatively of additionally, the second paging message may indicate that all devices received the first paging message should respond. The second paging message may also include a list of device identifiers of the one or more devices that should not respond to the second paging message. The list of device identifiers of the one or more devices that should not respond to the second paging message may identify the devices that already responded to the first paging message. An IoT device that receives the second paging message and is a member of the group of devices that are requested to respond or is considered a member of the “all devices” group may determine to not respond to the second paging message if the identity of the IoT device is included in the list of device identifiers of devices that should not respond to the second paging message. A benefit of this approach may be that duplicate responses from the same IoT device can be avoided and the IoT device may not need to store information about paging messages that it already received and/or already responded to.

Alternatively or additionally, the first paging message may include a group identity and a first mask value. The mask value and the group identity can be used by the device to determine if the IoT device should respond to the paging message. For example, the IoT device may decide to respond only if it is a member of the identified and group and if certain bit(s) of the mask are set. When the WTRU (e.g., a reader or A-RAN) sends the second paging message, the WTRU may decide to include the same group ID that was included in the first paging message but may also decide to include a different (i.e., second) mask value in the second paging message. Compared to the first mask value, the second mask value may be set such that different IoT device(s) may respond to the second paging message or may be set such that fewer IoT device(s) are requested to respond to the second paging message. For example, the second mask value may be set such that the devices that responded to the first paging message are not requested to respond to the second paging message.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method for use in a wireless transmit/receive unit (WTRU), the method comprising:
receiving, from a network node, a message comprising device information and paging configuration information, wherein the paging configuration information includes paging retransmission instructions;
transmitting, based on the device information, to a group of devices, a first paging message; and
based on receiving one or more paging responses or receiving no responses, transmitting, based on the paging retransmission instructions, a second paging message with an indication of paging retransmission.

2. The method of claim 1, wherein the first paging message comprises an inventory request, a command, and an inventory request with a command, and wherein the second paging message comprises an inventory request, a command, and an inventory request with a command.

3. The method of claim 1, wherein the paging retransmission instructions comprises a first instruction indicative of retransmission not required, a second instruction indicative of retransmission required, and a third instruction indicative of conditional retransmission required.

4. The method of claim 3, wherein the paging configuration information with the second instruction further comprises a number of retransmission attempts, a frequency for paging retransmission, and a duration of paging retransmission.

5. The method of claim 3, wherein the paging configuration information with the third instruction further comprises a threshold, a number of retransmission attempts, a frequency for paging retransmission, and a duration of paging retransmission.

6. The method of claim 5, further comprising:
determining that a number of the received one or more paging responses is less than the threshold; and
transmitting, based on that the number is less than the threshold, the second paging message with the indication of paging retransmission.

7. The method of claim 1, further comprising:
receiving, after transmitting the second paging message with the indication of paging retransmission, one or more paging responses that include one or more response numbers associated with the respective one or more paging responses.

8. The method of claim 1, further comprising:
transmitting, based on receiving no paging responses after transmitting the second paging message with the indication of paging retransmission, to the network node, a report indicating a number of paging retransmission attempts, a time frame, device information associated with the group of devices, and area information associated with the group of devices.

9. The method of claim 1, wherein the second paging message includes one or more identifiers associated with one or more devices that are not to respond to the second paging message, wherein the WTRU received the one or more paging responses to the first paging message from the one or more devices of the group of devices.

10. The method of claim 1, wherein the WTRU is a reader and the group of devices is a group of ambient internet of things (AIoT) devices, and wherein the network node comprises at least one of an application function (AF) or an ambient internet of things function (AIoTF).

11. A wireless transmit/receive unit (WTRU) comprising:
a processor;
a receiver; and
a transmitter,
the processor and the receiver configured to:
receive, from a network node, a message comprising device information and paging configuration information, wherein the paging configuration information includes paging retransmission instructions; and
the processor and the transmitter configured to:
transmit, based on the device information, to a group of devices, a first paging message; and
on a condition that one or more paging responses are received or no responses are received, transmit, based on the paging retransmission instructions, a second paging message with an indication of paging retransmission.

12. The WTRU of claim 11, wherein the first paging message comprises an inventory request, a command, and an inventory request with a command, and wherein the second paging message comprises an inventory request, a command, and an inventory request with a command.

13. The WTRU of claim 11, wherein the paging retransmission instructions comprises a first instruction indicative of retransmission not required, a second instruction indicative of retransmission required, and a third instruction indicative of conditional retransmission required.

14. The WTRU of claim 13, wherein the paging configuration information with the second instruction further comprises a number of retransmission attempts, a frequency for paging retransmission, and a duration of paging retransmission.

15. The WTRU of claim 13, wherein the paging configuration information with the third instruction further comprises a threshold, a number of retransmission attempts, a frequency for paging retransmission, and a duration of paging retransmission.

16. The WTRU of claim 15, wherein the processor and the transmitter are configured to:
determine that a number of the received one or more paging responses is less than the threshold; and
transmit, based on that the number is less than the threshold, the second paging message with the indication of paging retransmission.

17. The WTRU of claim 11, wherein the processor and the receiver are configured to receive, after transmitting the second paging message with the indication of paging retransmission, one or more paging responses that include one or more response numbers associated with the respective one or more paging responses.

18. The WTRU of claim 11, wherein the processor and the transmitter are configured to transmit, on a condition that no paging responses are received after transmitting the second paging message with the indication of paging retransmission, to the network node, a report indicating a number of paging retransmission attempts, a time frame, device information associated with the group of devices, and area information associated with the group of devices.

19. The WTRU of claim 11, wherein the second paging message includes one or more identifiers associated with one or more devices that are not to respond to the second paging message, wherein the receiver received the one or more paging responses to the first paging message from the one or more devices of the group of devices.

20. The WTRU of claim 11, wherein the WTRU is a reader and the group of devices is a group of ambient internet of things (AIoT) devices, and wherein the network node comprises at least one of an application function (AF) or an ambient internet of things function (AIoTF).
